(19) United States
(12) Patent Application Publication
(10) Pub. No.: US 2011/0194117 A1
(43) Pub. Date: Aug. 11, 2011

(54) MIRROR-TILT-INSENSITIVE FOURIER TRANSFORM SPECTROMETER

(75) Inventors: Huikai Xie, Gainesville, FL (US); Andrea Pais, Columbia, MD (US); Lei Wu, Covina, CA (US); Sean Robert Samuelson, Gainesville, FL (US); Shuguang Guo, Guangdong (CN)

(73) Assignee: UNIVERSITY OF FLORIDA RESEARCH FOUNDATION, INC., Gainesville, FL (US)

(21) Appl. No.: 13/123,683

(22) PCT Filed: Jan. 11, 2010
(86) PCT No.: PCT/US2010/020634

§ 371 Date: Apr. 11, 2011

Related U.S. Application Data
(60) Provisional application No. 61/147,587, filed on Jan. 27, 2009.

(51) Int. Cl. G01J 3/45; G01J 3/08

(52) U.S. Cl. 356/452

(57) ABSTRACT

Methods and designs for providing reduced sensitivity to mirror tilt in Fourier transform spectrometers are disclosed. According to an embodiment for two-directional tilt compensation, the FT spectrometer can include a beam splitter positioned to receive an incoming beam from a light source and split the incoming beam into a first sub-beam and a second sub-beam, a corner-cube retroreflector positioned to receive the first sub-beam from the beam splitter, a dual reflective mirror positioned to receive the first sub-beam from the corner-cube retroreflector at one surface and the second sub-beam at the other surface. An optical path delay can be created using a set of mirrors, tilting the beam splitter and/or a glass cube.

### CROSS REFERENCE TO RELATED APPLICATION

This application claims the benefit of U.S. Provisional Application Ser. No. 61/147,587, filed Jan. 27, 2009, which is hereby incorporated by reference in its entirety, including all figures, tables and drawings.

### BACKGROUND OF INVENTION

Fourier transform spectroscopy (FTS) is a measurement technique where spectra are collected based on the measurements of the temporal coherence of a radiative source. FTS can be applied to a variety of spectroscopic applications for both visible and infrared spectral ranges. FTS is particularly popular in mid-wave and long-wave infrared (IR) spectroscopy due to the difficulties other spectroscopy techniques have in facing those wavelength ranges. Because of the common application of FTS to the IR wavelengths, FTS is often referred to as Fourier transform infrared (FTIR) spectroscopy.

FTIR spectroscopy captures the molecular “fingerprints” of unknown substances. To accomplish this task, an IR light source is shined on an unknown substance. The IR energy from the IR light source interacts with the molecules of the substance. At this time, some of the IR energy is absorbed or transmitted through the substance, depending on the chemical bonds and functional groups that make up the object. Each functional group and bond is unique and, thus, creates a unique absorbance spectral pattern. Examination of the transmitted light can reveal how much energy is absorbed at each wavelength. By monitoring this absorbance spectral pattern, it is possible to link these different patterns to their corresponding functional groups and identify the composition of the object and/or the concentration of a particular compound or molecule. In addition to functional groups, hydrogen bonding, molecular conformations, and even chemical reactions can be determined by analyzing these absorption spectral patterns. The quantity of each component of a mixture may also be determined by observing the “peak” sizes of the absorbance patterns.

For non-FT spectroscopy, often a tunable light source or a spectrometer based on a dispersive device such as a grating or a Fabry-Perot (FP) etalon (or interferometer) is used. For non-FT spectroscopy, the optical power corresponding to a specific wavelength with certain bandwidth is detected individually. In contrast, FT spectroscopy does not need a tunable source, a dispersive device, or a FP etalon. Instead, the detector of a FT spectrometer collects the entire radiation power of all spectra. The spectral information is then extracted through a simple Fourier transform. In more detail, FTIR spectroscopy is a measurement technique where, instead of recording the amount of energy absorbed in each individual spectral range, the IR light including the entire spectra is collected by a single IR detector. Then, a mathematical Fourier transform is performed on the signal to provide a spectrum. A FT spectrometer can be viewed as an interferometer. In operation, a light beam that comes out of the interferometer goes into a sample compartment wherein the light beam interacts with the given sample and is either transmitted through or reflected off of the surface of the sample, depending on the particular type of analysis in question. From this reflection or transmission, photons with specific frequencies are absorbed by the sample. After exiting the sample compartment, the light beam reaches the detector of the FTIR spectrometer and is measured to produce the interferogram signal. This signal gives the intensity of the energy absorbed as a function of time and position of the moving mirror of the FTIR spectrometer. Of interest are the aforementioned frequencies at which these “intensity peaks” or energy absorptions occur. The frequencies are “encoded” into the interferogram signal as the mirror moves. Consequently, by using the mathematical operation known as the Fourier transform to transform the time domain information from the interferogram to the frequency domain, the spectral information of the sample can be uncovered for analysis.

FTIR spectroscopy can play an important role in chemical/biosensing applications for homeland security, food safety, environmental safety and battlefields. FTIR, together with a spectral library (stored, for example, in on-board intelligence), can be used to quickly identify the presence of particular agents.

To accomplish FTIR spectroscopy, a Michelson interferometer with a movable mirror can be used. Referring to FIG. 1A, a basic system utilizes a light beam 10 shined on a beam splitter 11, which may be a semi-transparent mirror. Half of the beam is reflected and directed toward a fixed mirror 12, and the other half is transmitted though and directed toward a movable mirror 13. The movable mirror 13 changes the optical path of the reference arm. The beams eventually reflect from their mirrors and meet at the beam splitter 11, where the “sum” of the beams gets redirected to a detector 14. The detector 14 records an interferogram generated by the interference of the two returning beams. Spectra of the light source are obtained by performing Fourier transform on the recorded interferogram signal. The device works by using the interference resulting from the “sum” of the beams. If two light waves that superimpose are “in phase” with respect to each other, their amplitudes will add up and a constructive interference or maximum brightness will form. On the other hand if they are “out of phase,” destructive interference or minimum brightness will appear.

To obtain the correct spectral information, the mirror position must be accurately measured. However, the tilt of the movable mirror will cause a mix of interferogram signals from a range of the mirror scanning. This mirror tilting may seriously decrease the spectral resolution. For instance, a 1° tilt may result in 10 nm spectral broadening in some FTIR systems.

Thus, a tilt-free translatory movement of the movable mirror is highly desired because the interferogram signal is very sensitive to the tilting of the movable mirror which can easily cause misalignment of the two returning light beams.

Referring to FIG. 1B, the shift of the returning beam at the beam splitter 11 from a tilted movable mirror 13 is proportional to the distance between beam splitter 11 and the movable mirror 13. However, in reality, it is difficult to generate a completely tilt-free movement of the movable mirror. In conventional FTIR spectroscopy, the minimization of the mirror tilting is usually obtained by using complex and bulky control systems to precisely control the movement of the movable mirror, or by replacing the planar mirror with a corner cube retroreflector for self-compensation of the beam shift caused by mirror tilting.

Accordingly, a number of challenges exist for FTIR miniaturization and accuracy, including addressing the bulky tilting compensation systems.

MEMS technology has emerged as a powerful solution for miniature and inexpensive FTIR spectroscopy due to the small size and low cost of MEMS devices. In MEMS-based FTIR systems, the movable mirror is replaced by a vertically scanning MEMS mirror. MEMS mirrors typically have larger tilting angles than conventional mirrors. However, the tilting-compensation solutions of conventional FTIR systems may not be applicable to MEMS-based FTIR due to the large sizes of the components needed for the compensation.

Thus, there exists a need in the art for an improved tilting compensation mechanism, and tilting compensation mechanisms applicable to MEMS-based FTIR.

### BRIEF SUMMARY

Embodiments of the present invention relate to a Fourier transform (FT) spectrometer capable of reduced sensitivity to mirror tilt. According to an embodiment, a method is provided that is capable of compensating for tilt of a movable mirror of a FT spectrometer.

In an embodiment, a FT spectrometer is provided that incorporates a tilt compensation scheme. The FT spectrometer can include a beam splitter that splits an incoming beam (either from a light source or transmitted through a sample) into two sub-beams and directs the sub-beams through a first optical path and a second optical path to a movable mirror. The split beams reflect off of mirrors in the first optical path, mirrors in the second optical path, and the movable mirror and return through the beam splitter, where they recombine and are directed to a detector.

According to an embodiment, a dual reflective micromirror can be used as the movable mirror in the subject FT spectroscopy (FTS) system to differentially generate the optical path-length difference.

In one embodiment, a FTS system is provided that includes a beam splitter, a cube-corner retroreflector, a MEMS micromirror, a fixed mirror, and a photodetector. In a further embodiment, several right-angle mirrors can be used to compensate the beam shift caused by the mirror tilting.

According to an aspect of the present invention, conventional spectrometer designs can be easily modified in accordance with embodiments of the present invention to reduce mirror tilt sensitivity.

According to another aspect of the present invention, a miniaturized spectrometer can be provided incorporating embodiments of the subject mirror-tilt insensitivity methods.

### BRIEF DESCRIPTION OF DRAWINGS

FIGS. 1A and 1B show a schematic of a FT spectrometer; FIG. 1A illustrates intended operation of the FT spectrometer and FIG. 1B illustrates the beam shift by mirror tilt.

FIGS. 2A-2C show schematics of a FT spectrometer in accordance with an embodiment of the present invention; FIG. 2A shows an arrangement for one-directional tilt compensation, FIG. 2B shows an arrangement with a 1 degree x-axis tilt compensation for Mₘ tilt, and FIG. 2C shows an arrangement with a −1 degree x-axis tilt compensation for Mₘ tilt.

FIGS. 3A-3C shows schematics of a FT spectrometer in accordance with another embodiment of the present invention; FIG. 3A shows an arrangement for two-directional tilt compensation, FIG. 3B shows an arrangement with a 1 degree x-axis tilt compensation for Mₘ tilt, and FIG. 3C shows an arrangement with a 1 degree y-axis tilt compensation for Mₘ tilt.

FIGS. 4A and 4B show schematics of a FT spectrometer in accordance with yet another embodiment of the present invention.

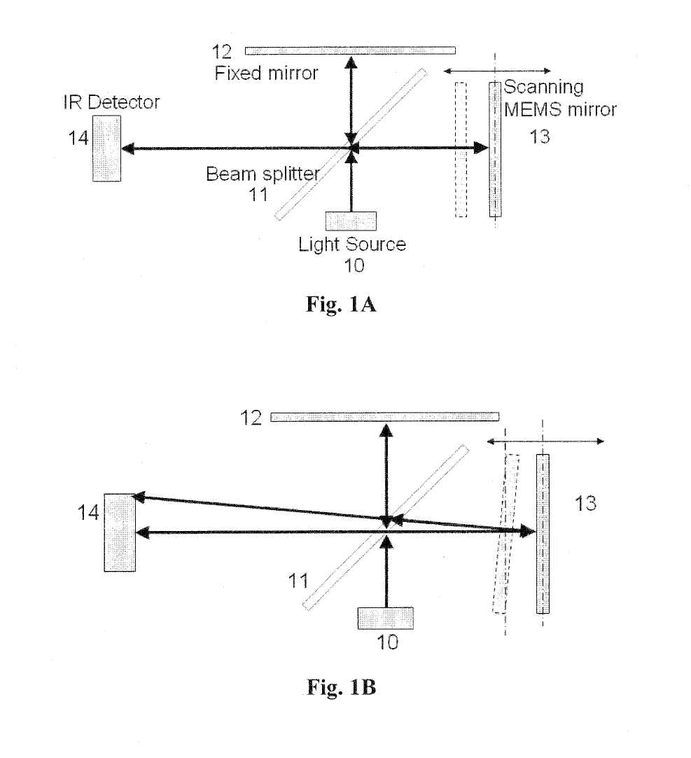

### DETAILED DISCLOSURE

The present invention relates to a FT spectrometer capable of reduced sensitivity to mirror tilt. Embodiments of the subject FT spectrometer can be provided for a mobile platform. Implementations of the subject invention can include, but are not limited to, FT interferometers, photodetectors, FT spectrometers, gas sensors, chemical sensors, and biosensors.

According to an embodiment, the subject FT spectrometer can include a modified Michelson interferometer having a movable mirror. The movable mirror can be a dual reflective micromirror. The dual reflective micromirror can be used to differentially generate the optical path-length difference. The subject FT spectrometer can include right-angle mirrors to further compensate the beam shift caused by the mirror tilting. In an embodiment, a three-plane cube-corner mirror can be utilized for two-directional tilt compensation. In a specific embodiment, the three-plane corner mirror can be realized using a cube-corner retroreflector.

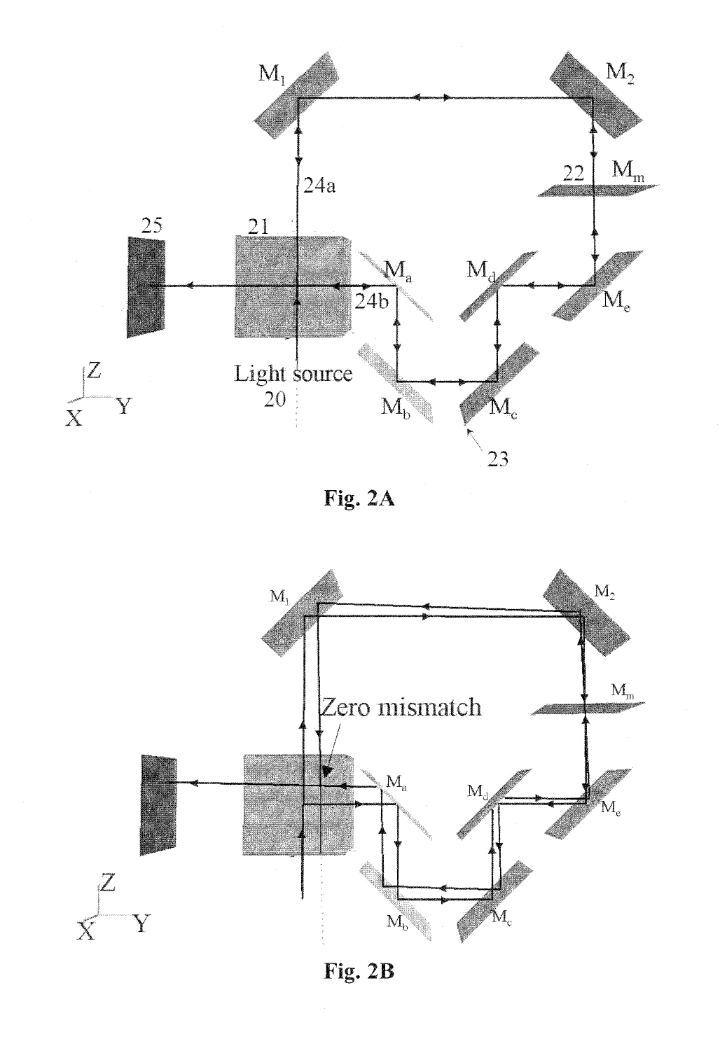

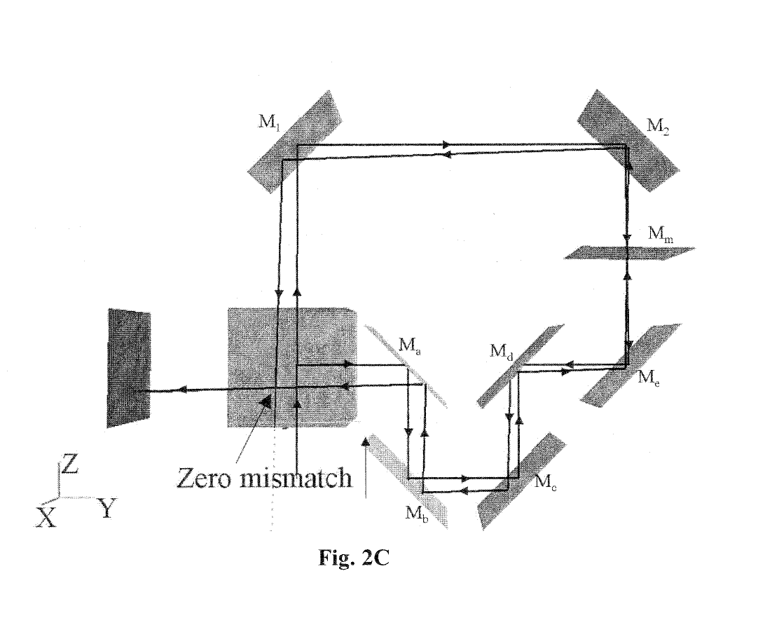

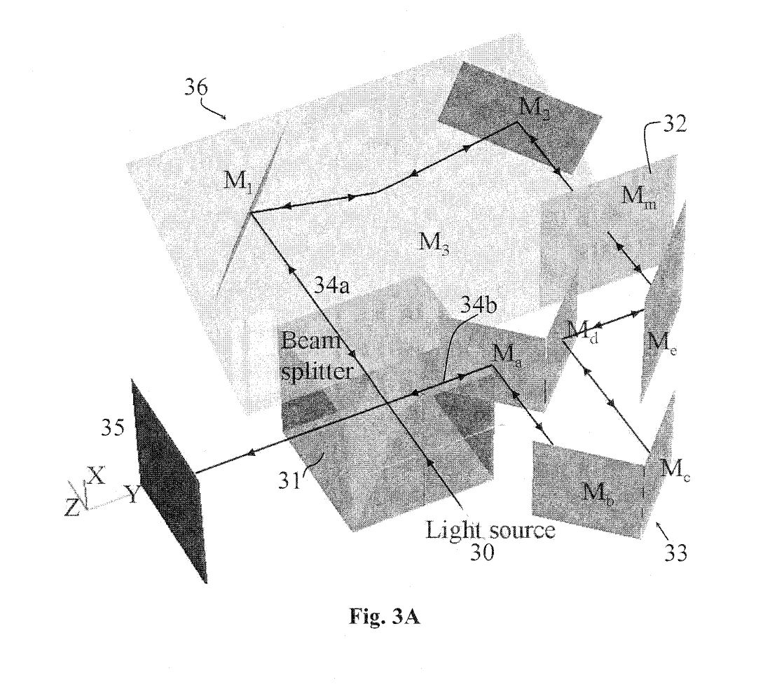

FIG. 2A shows a FT spectrometer including a one dimensional tilting compensation in accordance with an embodiment of the present invention. As shown in FIG. 2A, the FT spectrometer can include a light source 20, a beam splitter 21, a dual reflective movable mirror 22 (Mₘ), and a set of right-angle mirrors 23 for providing an optical delay path.

Here, the two light beams divided by the beam splitter 21 can be delivered to both surfaces of the dual reflective movable mirror 22 Mₘ, by mirrors M₁ and M₂ in a first path 24a and Mₐ, M_{b}, M_{c}, M_{d}, and Mₑ in a second path 24b. The returning light can be combined at the beam splitter 21 and directed to the detector 25. The detector 25 can record an interferogram generated by the interference of the returning light The two mirrors M₁ and M₂ in the first path 24a can be arranged as two orthogonally-oriented mirrors. The four right-angle mirrors 23 Mₐ, M_{b}, M_{c}, and M_{d} can be used to generate the optical path delay for matching the movable mirror 22 to be at the zero optical path position. When there is a small tilting angle (1°) on the movable mirror about x axis, the returning beam from the upper surface of the movable mirror Mₘ via the mirrors M₂ and M₁ is still parallel to the returning beam reflected from the lower surface of the movable mirror Mₘ via the right-angle mirrors Mₑ-Mₐ. Both returning beams have a shift from the original paths, but these two beams are parallel and the shifts are the same amount but in the opposite directions. Therefore, a zero mismatch of the two returning beams can be obtained when the movable mirror is at the zero optical path-length difference position. When the mirror scans, the mismatch is minimized to be just proportional to the mirror's physical scan range. For example, a 500 μm physical scan range by the mirror can generate an effective 2 mm optical path-length difference resulting in 5 cm⁻¹ spectral resolution, and just about 8 μm beam shift (beam size usually larger than half millimeter) for a tilting angle of 1°. FIGS. 2B and 2C respectively show the zero mismatch of the two returning beams when the movable mirror tilts ±1° about x axis.

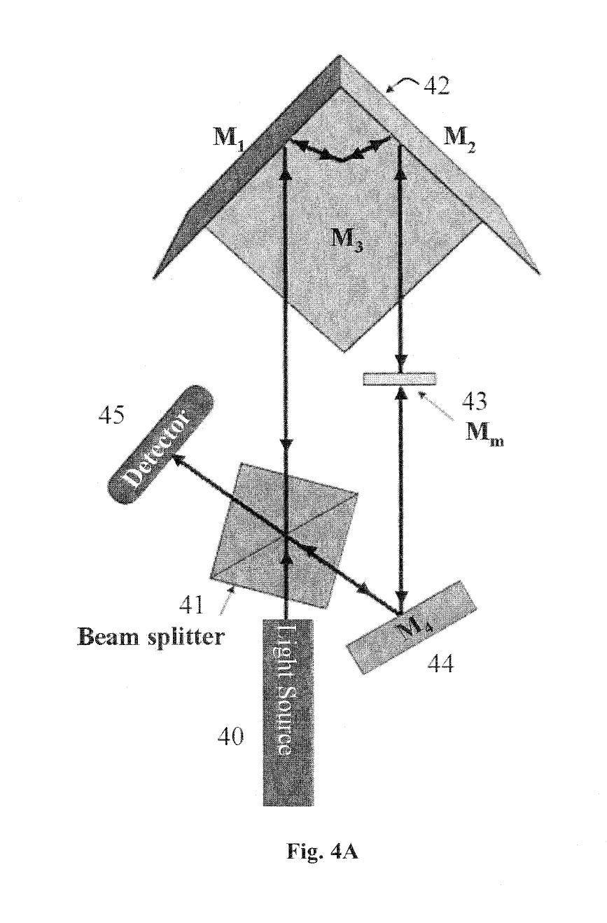

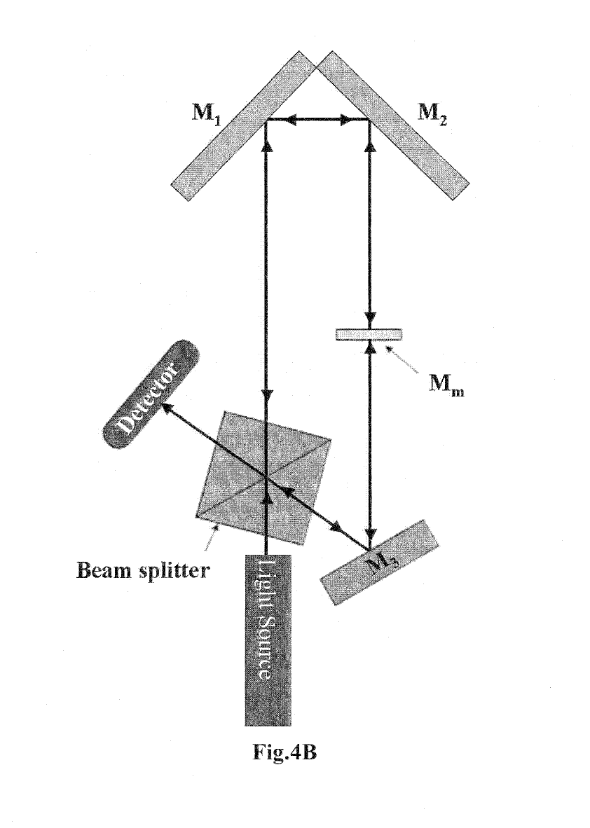

In a further embodiment, in addition to the four right-angle mirrors, or as an alternative, an optical delay unit can be positioned in one of the first and second paths 24a, 24b. The optical delay unit can be, for example, a glass cube. In yet another embodiment, the four right-angle mirrors can be omitted and the beam splitter can be tilted to generate a longer optical path length in one of the optical paths (see e.g., FIGS. 4A and 4B).

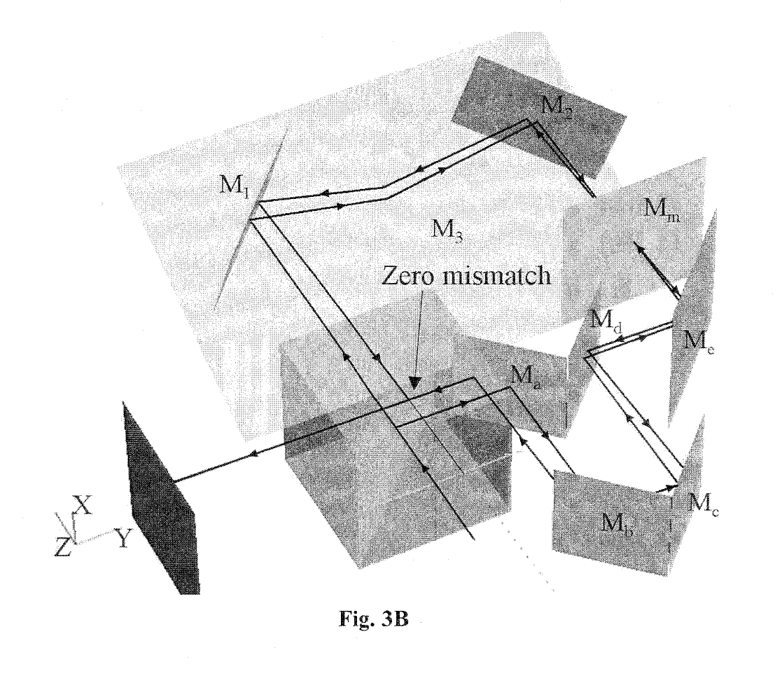

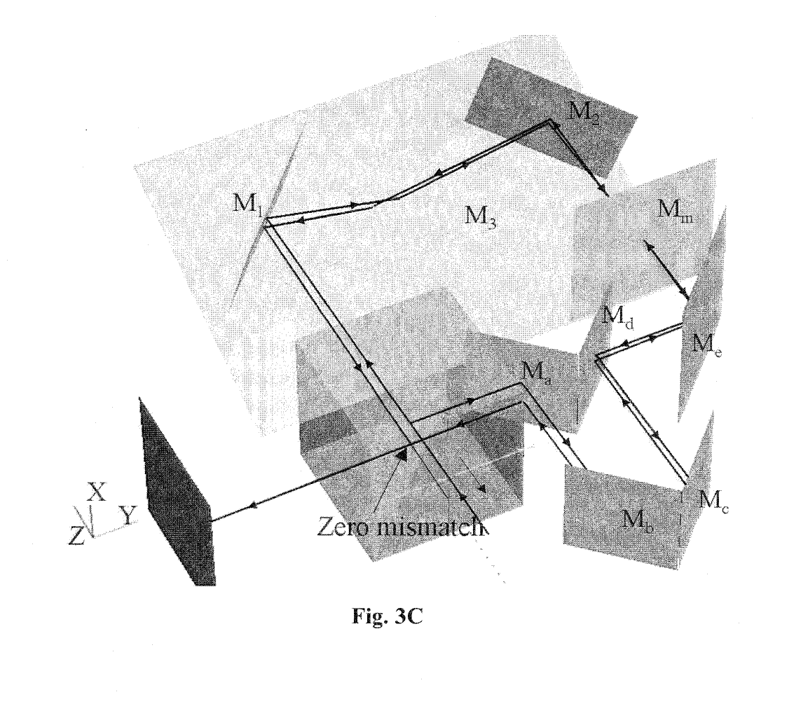

In a further embodiment, tilting can be compensated in more than one direction. For example, referring to FIG. 3A, an embodiment of the present invention can be used to simultaneously compensate mirror tilting in two directions (e.g., x-axis and y-axis). FIG. 3A shows a FT spectrometer including a two dimensional tilting compensation in accordance with an embodiment of the present invention. As shown in FIG. 3A, the FT spectrometer can include a light source 30, a beam splitter 31, a dual reflective movable mirror 32 (Mₘ), and a set of right angle mirrors 33 for providing an optical delay path in a similar configuration as the FT spectrometer arrangement shown in FIG. 2A, where the returning light is combined at the beam splitter 31 and directed to the detector 35. However, the configuration shown in FIG. 3A further includes a three-plane cube-corner mirror configuration 36 for one optical path (e.g. path 34a) in order to achieve the tilt compensation in both directions (e.g., x-axis and y-axis).

The three-plane cube-corner mirror configuration 36 can be realized using three right-angle mirrors M₁, M₂ and M₃. The three right-angle mirrors M₁, M₂ and M₃ are perpendicular to each other and form the three-plane cube-corner mirror, which is tilted around the y-axis by a certain angle to allow the output beam from M₃ to be delivered to the upper surface of the movable mirror 32 Mₘ. With the three right-angle mirrors, the shift of one returning light beam by mirror tilting around either the x-axis or the y-axis can be tracked and compensated by the same but opposite shift of the returning beam from the other path (e.g., path 34b). FIG. 3B and FIG. 3C respectively show the zero mismatch of the two returning beams when the movable mirror tilts 1° around x axis and y axis. In certain embodiments, the three right-angle mirrors can be simply replaced by a corner cube retroreflector.

In an embodiment, the movable mirror can be a dual reflective movable mirror. The optical path-length difference differentially generated by the dual reflective mirror is four times that of the mirror's moving range, thus is doubled compared to that by the conventional single side movable mirror. Since the spectral resolution of the FTS is inversely proportional to the optical path-length difference, the resolution can be improved by a factor of two for a given mirror scan range. Accordingly, embodiments can incorporate differentially generated optical path-length difference using a dual-reflective micromirror, enhancing the resolution of the spectrometer.

In accordance with an implementation, embodiments can incorporate a dual reflective MEMS mirror along with a corner cube retroreflector to compensate for tilting. The dual reflective MEMS mirror inherently doubles the optical path-length difference and can also compensate for unidirectional tilt. In addition, the corner cube retroreflector can be used to compensate for bidirectional tilt due to the dual reflective MEMS mirror.

According to an embodiment, a corner cube retroreflector or cube-corner mirror can be employed in one of the optical paths for the purpose of tilting compensation. The optical path-length difference can be generated by the linear translatory scanning of a MEMS mirror with dual reflective surface on both sides. According to embodiments, fast and linear scanning of optical path-length difference (OPD) is possible. In addition, a miniaturized and low cost system can be provided due to the miniature scanning reflectors by the MEMS technology.

According to embodiments of the present invention, right-angle mirrors can be used to minimize the beam shift caused by possible tilting of the movable mirror in the FT spectrometer. Examples of such right angle mirrors can be seen in FIG. 3A, where vertical mirror Mₐ is shown at a right angle (90 degree) from vertical mirror M_{c} and vertical mirror M_{b} is shown at a right angle (90 degree) from vertical mirror M_{d}.

In another embodiment, the four vertical mirrors (Mₐ, M_{b}, M_{c}, M_{d}) used to generate the additional optical path for placing the movable mirror outside the corner cube can be omitted. In one such embodiment, such as shown in FIGS. 4A and 4B, the beam splitter can be tilted.

FIG. 4A shows a method of generating additional optical path for placing the movable mirror outside the corner cube by tilting the beam-splitter. In particular, the beam splitter 41 can be tilted such that an incoming beam from a light source 40 can be split into a first sub-beam directed to a cube-corner retroreflector 42, which then travels to a movable mirror 43 (Mₘ), and a second sub-beam directed to a fixed mirror 44 (M₄), which then travels to the movable mirror 43. The reflected beams return through the beam splitter 41 to recombine and be directed to a detector 45. An analogous method is shown in FIG. 4B where two orthogonal mirrors (M₁ and M₂) instead of the cube-corner retroreflector are used. According to embodiments, the movable mirror can be a MEMS-based dual reflective mirror.

In another embodiment, an optical delay unit can be used to generate the longer optical path length in one of the optical paths. The optical delay unit can be, for example, a glass cube.

In a further embodiment, a focusing lens can be included to reduce the scan range of the interference signal as it traverses the detector aperture from the beam-splitter.

In yet a further embodiment, a large aperture photodiode or photodiode array can be utilized as the interference signal (e.g., the combined reflected first and second sub-beams) scans the photodetector.

Conventional FT systems use single-side movable mirrors and bulky mechanisms to precisely control or minimize the tilt of the movable mirror. Compared to the existing products, embodiments of the present invention can have a small size and light weight. In addition, inexpensive and portable systems can be configured utilizing the tilt-insensitive methods in accordance with embodiments of the present invention. Furthermore, double spectral resolution can be achieved by using the dual reflective mirror. Advantageously, the subject methods can be applied to conventional spectrometer designs.

According to an embodiment, the two optical paths for generating the optical interference can be split by a single plane reflector with reflective surfaces on both sides, however, the optical beam in each path only reflects once on this reflector. In one embodiment, the reflector used for tilting compensation is a three-plane cube-corner mirror which is capable of compensating the optical distortion in multi-directions. Advantageously only a single reflection is used instead of the bulky multiple reflections required in certain prior technology

By utilizing the subject methods, implementations of FT spectrometers can be made insensitive to alignment of the scanning mirror.

In certain embodiments of the present invention, when not compensating for tilt, the movable mirror can be used to generate the optical path-length difference.

The embodiments described above are applicable to general FTS systems as well as FTIR spectroscopy systems.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

It should be understood that the examples and embodiments described herein are for illustrative purposes only and that various modifications or changes in light thereof will be suggested to persons skilled in the art and are to be included within the spirit and purview of this application.

We claim:

1. A Fourier transform (FT) spectrometer, comprising:
a beam splitter positioned to receive an incoming beam from a light source and split the incoming beam into a first sub-beam and a second sub-beam, the beam splitter also positioned to combine and direct a reflected first sub-beam and a reflected second sub-beam to a photodetector;
a cube-corner retroreflector positioned to receive the first sub-beam from the beam splitter;
a stationary mirror positioned to receive the second sub-beam from the beam splitter and reflect the second sub-beam; and
a movable mirror positioned to receive the first sub-beam and the second sub-beam respectively from the cube-corner retroreflector and the stationary mirror.

2. The FT spectrometer according to claim 1, wherein the movable mirror comprises a dual reflective surface, wherein a first reflective surface of the movable mirror receives the first sub-beam from the cube-corner reflector and a second reflective surface of the movable mirror receives the second sub-beam from the stationary mirror.

3. The FT spectrometer according to claim 2, further comprising a set of mirrors for generating optical path delay, the set of mirrors arranged to receive the second sub-beam from the beam splitter and direct the second sub-beam to the stationary mirror.

4. The FT spectrometer according to claim 1, wherein the movable mirror comprises a MEMS micromirror.

5. The FT spectrometer according to claim 1, wherein the photodetector comprises a large aperture photodiode or photodiode array used when the combined reflected first and second sub-beams are directed to the photodetector.

6. The FT spectrometer according to claim 1, further comprising a focusing lens in a signal path between the beam splitter and the photodetector.

7. The FT spectrometer according to claim 1, wherein the beam splitter is arranged having a tilt angle for generating an optical path-length difference.

8. The FT spectrometer according to claim 1, wherein the beam splitter is tilted to generate a longer optical path length in one of the first sub-beam and the second sub-beam.

9. The FT spectrometer according to claim 1, further comprising an optical delay unit disposed in an optical path of one of the first sub-beam and the second sub-beam.

10. The FT spectrometer according to claim 9, wherein the optical delay unit is a glass cube.

11. A Fourier transform (FT) spectrometer, comprising:
a beam splitter positioned to receive an incoming beam from a light source and split the incoming beam into a first sub-beam and a second sub-beam;
a first set of mirrors positioned to receive the first sub-beam from the beam splitter;
a second set of mirrors positioned to receive the second sub-beam from the beam splitter;
a dual reflective movable mirror positioned to receive the first sub-beam reflected from the first set of vertical mirrors at a first reflective surface and the second sub-beam from the second set of vertical mirrors at a second reflective surface; and
a detector, wherein a reflected first sub-beam from the first reflective surface of the dual reflective movable mirror and a reflected second sub-beam from the second reflective surface of the dual reflective movable mirror recombine at the beam splitter and become directed to the detector.

12. The FT spectrometer according to claim 11, wherein the first set of mirrors is arranged for a bidirectional tilt compensation.

13. The FT spectrometer according to claim 11, wherein the first set of mirrors is arranged as two orthogonally-oriented mirrors.

14. The FT spectrometer according to claim 11, wherein the first set of mirrors comprises a three-plane cube-corner retroreflector.

15. The FT spectrometer according to claim 11, wherein the second set of mirrors is arranged for providing an optical path delay.

16. The FT spectrometer according to claim 15, wherein the second set of mirrors comprises four mirrors arranged for permitting the movable mirror to be placed at a zero optical path position.

17. The FT spectrometer according to claim 16, wherein the four mirrors are configured as right angled pairs.

18. The FT spectrometer according to claim 11, wherein the beam splitter is tilted to generate a longer optical path length in one of the first sub-beam and the second sub-beam.

19. The FT spectrometer according to claim 11, further comprising an optical delay disposed in an optical path of one of the first sub-beam and the second sub-beam.

20. The FT spectrometer according to claim 19, wherein the optical delay unit is a glass cube.
